(19) United States
(12) Patent Application Publication
(10) Pub. No.: US 2002/0026446 A1
(43) Pub. Date: Feb. 28, 2002

(54) Secure host computer internet gateway

(76) Inventors: Gaston J. Groos III, Woodlands, TX (US); Gregory S. St. Denis, Houston, TX (US)

Correspondence Address: FULBRIGHT & JAWORSKI L.L.P., A REGISTERED LIMITED LIABILITY PARTNERSHIP, 600 CONGRESS AVENUE, SUITE 2400, AUSTIN, TX, 78701, US

(21) Appl. No.: 09/761,870

(22) Filed: Jan. 16, 2001

Related U.S. Application Data
(60) Provisional application No. 60/189,944, filed on Mar. 16, 2000.

(51) Int. Cl. G06F 7/00

(52) U.S. Cl. 707/102

(57) ABSTRACT

The present invention addresses both the problem of Internet access and security by providing an interface to a host computer that does not utilize a direct network connection between the host computer and the internet. In one embodiment, a computer system is provided that comprises two servers that interact through a shared-file database. One server is connected to the Internet and makes requests to the other through the shared-file database. The second server is connected to a host computer, and only performs the requests if they are among a pre-defined set of allowable transactions corresponding to a permissible set of request commands. The shared-file database is the substantially only resource shared by the two servers, and it thus serves as a secure buffer between Internet users and the host computer. Because the host computer is not connected to the Internet, it is not susceptible to many forms of unauthorized use. The transactions that can be initiated on the web server and performed on the host computer are restricted to a pre-defined set of transactions. By funneling requests for host transactions through a database buffer, and by limiting access to a pre-defined set of transactions, the computer system provides a secure method of enabling Internet users to access host computers.

This specification claims the benefit of and expressly incorporates by reference provisional application Ser. No. 60/189,944, entitled “Secure Internet Gateway For Web Enabling Legacy Applications,” filed Mar. 16, 2000.

### TECHNICAL FIELD OF THE INVENTION

The present invention relates generally to computer interfaces and in particular to secure data access systems.

### BACKGROUND

As the Internet has become the ubiquitous medium for telecommunications and the transport of data, the software industry at large and companies in the technology business have developed so-called “e-commerce” solutions. E-commerce solutions have transformed the Internet into a global storefront. Web pages advertise goods and services that consumers and businesses can purchase on-line. This growth in on-line commercial activity has created a substantial need to make the data and applications that companies have on their existing host computers (e.g., legacy systems) accessible via the Internet. Unfortunately, a redesign of these host computer applications and databases would be prohibitively expensive, running in the billions, perhaps trillions of dollars.

Access alone is not the only important consideration when creating on-line access to host computers. The data and applications that run on these machines typically must be protected from undesired or unauthorized access. Information systems managers go to considerable lengths and expense to ensure that the systems which run their businesses are not exposed to the risk of software malfunctions or computer hackers. Before putting their mission-critical systems and databases on-line, these managers need assurance that these systems and databases will be secure. Unfortunately, conventional security schemes—especially those that rely alone on firewalls to prevent unauthorized users from getting access to the secure data—are not sufficiently reliable.

Accordingly, what is needed is an improved system and method for implementing secure Internet access to a host computer.

### SUMMARY OF THE INVENTION

The present invention addresses both the problem of Internet access and security by providing an interface to a host computer that does not utilize a direct network connection between the host computer and the internet. In one embodiment, a computer system is provided that comprises two servers that interact through a shared-file database. One server is connected to the Internet and makes requests to the other through the shared-file database. The second server is connected to a host computer, and only performs the requests if they are among a predefined set of allowable transactions corresponding to a permissible set of request commands. The shared-file database is the substantially only resource shared by the two servers, and it thus serves as a secure buffer between Internet users and the host computer. Because the host computer is not connected to the Internet, it is not susceptible to many forms of unauthorized use. The transactions that can be initiated on the web server and performed on the host computer are restricted to a pre-defined set of transactions. By funneling requests for host transactions through a database buffer, and by limiting access to a pre-defined set of transactions, the computer system provides a secure method of enabling Internet users to access host computers.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts a block diagram of one embodiment of a secure host computer—internet interface system of the present invention.

FIG. 2 depicts a block diagram of a web server from the system of FIG. 1.

FIG. 3 shows one embodiment of a routine for providing request files to a shared-file database in the system of FIG. 1.

FIG. 4 shows one embodiment of a routine used by the web server of FIG. 2 to retrieve response files from a shared-file database in the system of FIG. 1.

FIG. 5 shows example portions of an HTML page used in a web application in one embodiment of the present invention.

FIG. 6 shows an Active Server code segment used to make the HTML page depicted in FIG. 5 interactive.

FIG. 7 depicts an example of an Internet API for reading from and writing to the shared file database.

FIG. 8 depicts a block diagram of one embodiment of the host-side server and shared-file database from the system of FIG. 1.

FIG. 9 shows a routine used by a host-side agent in the host-side server of FIG. 8 .

FIG. 10 shows a routine used by the host-side agent to retrieve request files from the shared-file database.

FIG. 11 displays a portion of the code used in an example for illustrating one aspect of the present invention.

FIG. 12 displays a portion of the code used in the example of FIG. 11.

FIG. 13 depicts a block diagram of the host-side server containing a shared-file database.

FIG. 14 depicts a block diagram of another specific embodiment of an interface system of the present invention.

### DETAILED DESCRIPTION

System Overview

The computer system, according to a preferred embodiment of the present invention, comprises a web server, a shared-file database, and a host-side server, operable to allow an Internet user to access a host computer. The web server is connected to the Internet and provides Internet access to the system. The host-side server is connected to a host computer and enables the system to perform a definable set of host computer transactions. The shared-file database is accessible to both the web server and the host-side server. It provides a secure interface between the two servers. The shared-file database may reside on the host-side server, or on another computer connected to the system.

In a preferred embodiment, both the web server and the host-side server provide and retrieve files from the shared-file database. The web server provides request files to the shared-file database. The host-side server retrieves these request files, determines whether the requested service is among the defined set of host computer transactions that are permitted, and directs the host computer to process appropriate transactions. Once a transaction is completed, the host-side server receives data from the host computer and generates a response file which the server provides to the shared-file database. The web server retrieves this response file and processes its contents, making them available to Internet users through a web application. Because the shared-file database is the substantially only shared resource between the two servers, the host-side server is protected from a direct attack via the Internet.

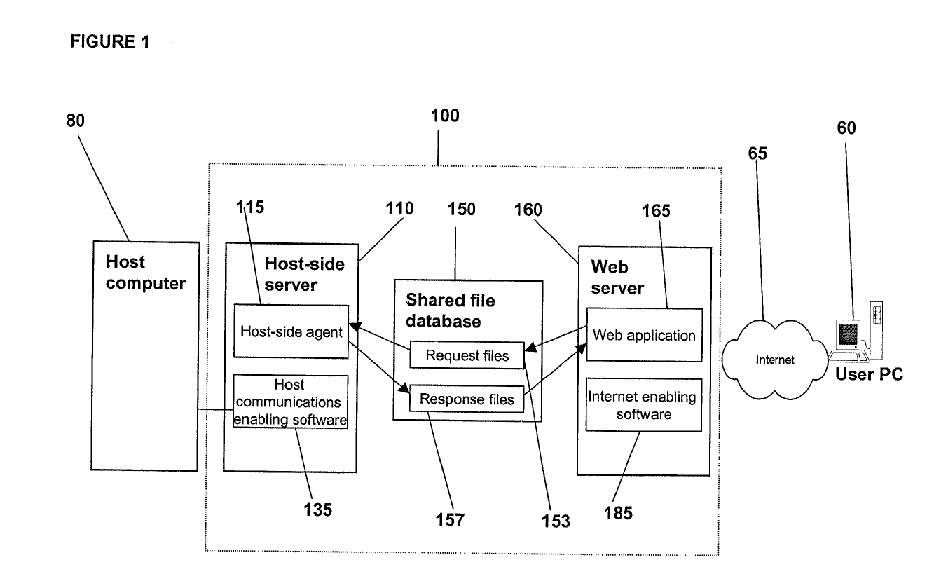

FIG. 1 shows one embodiment of a computer system 100 of the present invention. System 100 communicatively links a host computer 80 to at least one user PC 60 via the Internet 65. The connection to the host computer may use SNA, Asynchronous protocols, protocols that connect through LAN gateways, or any other protocol for connecting to the host computer. For the purposes of this invention, the Internet, which is commonly considered to comprehend the network of networks known as the World Wide Web, should also be construed to include private networks, corporate extranets, and other networks that operate to connect computers together. The host computer 80 can be any hardware platform, including but not limited to a mainframe, server, workstation, personal computer, or a network of computers that contain data that may be stored in databases. The user PC 60 can be any form of Internet access device, including a computer or Internet appliance.

In the embodiment depicted in FIG. 1, the computer system 100 comprises a web server 160, a host-side server 110, and a shared-file database 150. The web server 160 and the host-side server 110 are operably connected to the shared-file database 150. The web server 160 and the host-side server 110 can be implemented with any suitable computer, including but not limited to a mainframe, workstation, or personal computer, running an operating system that may be Windows NT, UNIX, LINUX, or any other computer operating system. The web server has at least one web application 165 and Internet enabling software 185. The host-side server has a host-side agent 115 and host communications enabling software 135.

The web application 165 provides request files 153 to and retrieves response files 157 from the shared-file database 150. It may be any application that performs these tasks and is accessible to the Internet. The web application 165 is connected to the Internet via Internet enabling software 185, also installed on the web server 160. Internet enabling software 185 facilitates the web site for providing Internet users with access to Web application 165. Internet enabling software 185 may be implemented with any suitable Internet enabling software such as Apache, Microsoft IIS, and Netscape Enterprise Server.

The shared file database 150 is operably connected to the web application 165 (as well as to the host-side agent 115) and holds request files 153 and response files 157. A request file contain the commands and/or instructions for carrying out pre-defined, allowable tasks on the host computer 80 responsive to a request from a web user. In turn, a response file 157 contains data, generated from the host computer 80, that is responsive to a processed request file. Other types of databases, including but not limited to flat-file, hierarchical, relational, and object-oriented databases may also be used to hold the commands, instructions, and data that the web application 165 provides and retrieves through the request and response files 153, 157, respectively. In addition, the shared-file database may be implemented using a custom block of code, or by implementing a commercial database product, including but not limited to MS-ACCESS, ORACLE, INFORMIX databases. In one implementation in which the shared-file database resides on the host-side server, the web server accesses the database through a connection which may be implemented using a hub, by placing the shared-file database on a dual-ported disk drive connected to both servers, or through another physical connection.

The host-side agent 115 may be a program or a set of programs that retrieve and process request files 153, initiate host computer transactions, process host computer responses, and provide response files 157 to the shared-file database 1-50. The host-side agent 115 is installed on the host-side server 110 and is operably connected to the host communications enabling software 135. The host communications enabling software 135 may be a script, routine, program, or set of programs that exchange data and instructions between the host-side agent 115 and the host computer 80. For example, the host communications enabling software 135 may be a terminal emulator. In one embodiment, the host communications enabling software 135 is a screen scraper, providing data elements to the screen coordinates that an application running on the host computer 80 expects as input, and extracting output from the screen coordinates that the host computer 80 generates. This screen scraper functions by emulating a ‘dumb’ terminal. The host communications enabling software may also be an interface written to a specific host application, database interconnectivity software such as ODBC, or an interface that is appropriate to the type of host computer 80 used in the computer system 100.

The computer system 100 operates when a user PC 60 attached to the Internet 65 initiates a request for services on the web server 160, by invoking the web application 165 that is running on the Internet enabling software 185. Before reaching the web server 160, the user's request may pass through an Internet firewall or other security device. The web application 165 communicates with the host-side agent 115 running on the host server 110 through the shared file database 150. The web application 165 does this by providing a request file 153 containing one or more request commands and required data to the shared-file database 150.

The host-side agent 115, running on the host-side server 110, retrieves the request file 153 and processes the request for service. The host-side agent 115 is programmed to recognize a defined set of request commands that correspond to host computer services that the computer system 100 is authorized to execute. If the host-side agent 115 recognizes the request command, the host-side agent 115 communicates the request to the host computer 80 through the host-communications enabling software 135. If the request command is not recognized, then the hostside agent does not process the request. This denial of unauthorized service provides security for the host computer 80.

When the host-side server directs the host computer 80 to perform a transaction (i.e. execute a request command), the host computer 80 performs the service and communicates the results to the host-side agent 115 through the host communications enabling software. The host-side agent 115 communicates with the web application 165 by providing a response file 157 to the shared-file database 165. The web application 165 retrieves and processes the response file 157, then communicates with the user PC 60 through the Internet 65.

Web Side Server and Sub-Elements

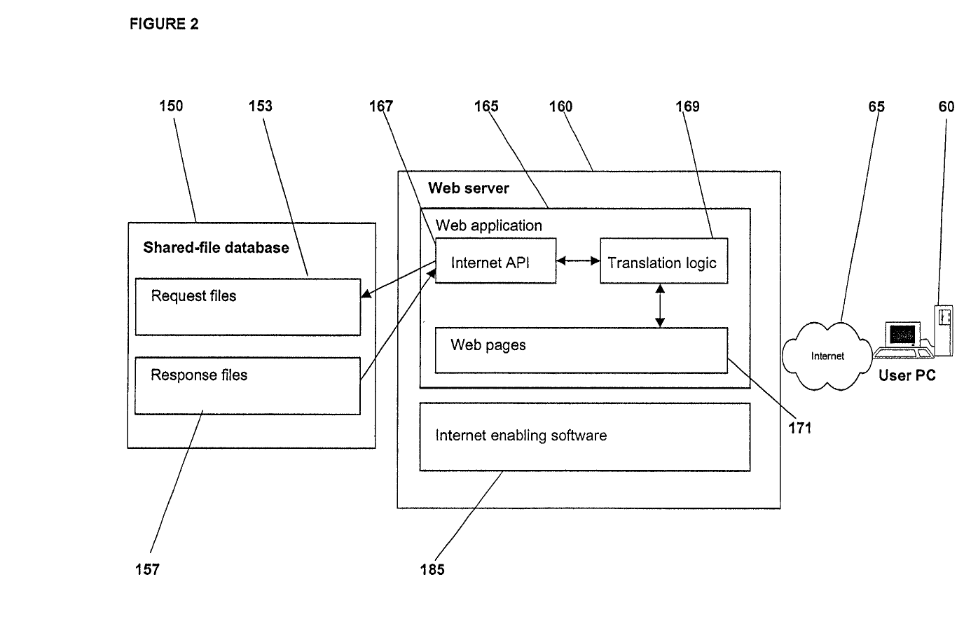

FIG. 2 depicts a block diagram of the web server 160, illustrating the interaction between the elements of the web application 165 and the shared file database 150. The web application 165 is comprised of web pages 171, translation logic 169, and an Internet API 167. The web pages 171 may include input pages, output pages, and transaction pages. Input pages collect requests from the web server 160. Output pages display information that had been retrieved from the host computer 80. Transaction pages define the set of host computer transactions that are enabled for a given configuration of the computer system 100. An important feature of the invention is the ability to specify these transaction pages to limit host computer access to a defined set of transactions.

The web pages 171 are typically formatted in a hypertext mark-up language (HTML) but may be formatted using other technologies. Web pages 171 may be further enabled with programs or scripts implemented using a common gateway interface (CGI) written in Perl, C, C++, Java, or another language that supports CGI, or using a web-enabling toolkit such as Active Server. These programs or scripts can be used to make the web pages 171 interactive. The web pages 171 are the interface through which the user PC 60 requests computer system 100 to perform a host computer transaction.

The translation logic 169 may consist of a script, routine, program, or set of programs that receives data and instructions in one format and translates them into another format. The translation logic may be embedded in the web pages 171, the Internet API 167, or implemented as a distinct body of computer code. In the embodiment of FIG. 2, the translation logic 169 is operably connected to the web pages 171 and the Internet API 167. The translation logic 169 is bi-directional. Data coming from the web pages 171 is translated into the format of the shared-file database 150, and data in the shared-file database format is translated into the format of the web pages. In addition to reformatting data and instructions, the translation logic may contain functionality to disallow transaction requests that are not part of the pre-defined set of transactions allowed for the host computer system 100.

The Internet API 167 may consist of a function, set of functions, program, or set of programs that provide request files 153 and retrieve response files 157 from the shared-file database 150 for processing. Additional processing of files, including but not limited to file encryption and error correction may also be provided by the Internet API. The Internet API 167 is operably connected to the shared-file database 150, and may be connected to the web pages 171 or to the translation logic 169 of the web application 165. The Internet API 167 may also be attached to a pre-existing web application to integrate it into the computer system 100.

When a transaction request is made by a User PC 60, the web application 165 captures the request and any required data from the web pages 171. Next, the application uses the translation logic 169 to structure the request into a format that conforms with the shared-file database 150. If the transaction request is recognized as an allowable request by the web application 165, then the web application 165 provides a request file 153 corresponding to the transaction request to the shared-file database 150 by invoking the Internet API 167. Conversely, if the transaction is not authorized, the web application 165 does not generate the request file 153. By providing request files only for authorized transactions, the web application protects the host computer 80, its applications, and data from unauthorized access. Additional protection may be provided in the host-side server 110 and the host computer 80 itself.

When a response file 157 is created by the host-side server 110, the Internet API 167 receives the response file and copies its contents into a data structure that can be processed by the web application 165. In a computer system 100 in which multiple requests are processed simultaneously, the contents of this file may include identifiers used to match response files 157 to the specific web pages 171 and users that requested them. The Internet API 167 is the single interface between the web application 165 and the shared-file database, thus ensuring that transaction requests and host responses are processed in a consistent manner.

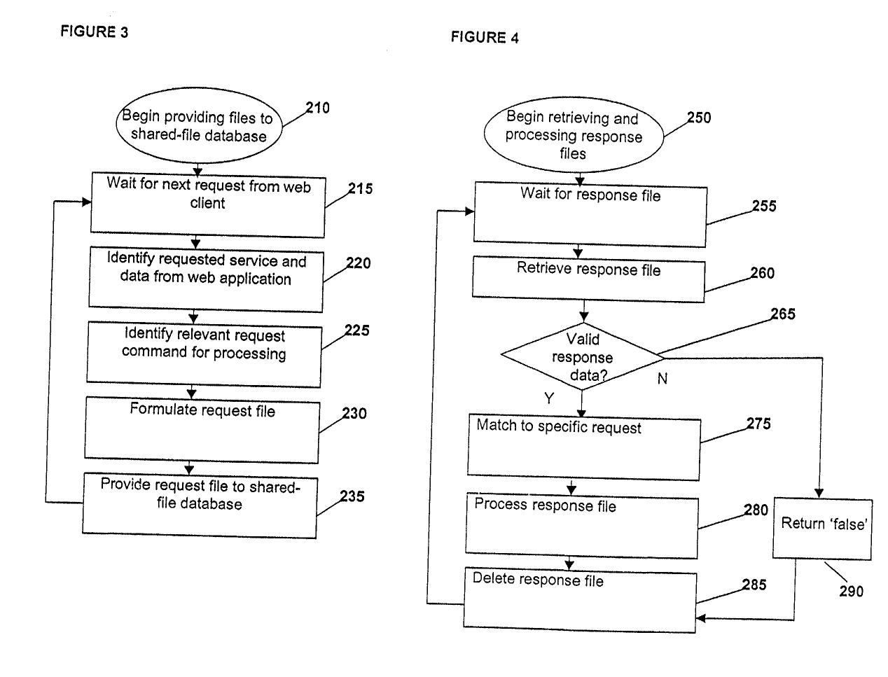

FIG. 3 illustrates one embodiment of a routine used by the web application 165 to provide request files 153 to the shared-file database 150. At step 210, the routine to provide request files 153 begins. At step 215, the routine waits until there is a request from a web client. When there is a request, the routine initiates step 220 which identifies which service is requested and identifies any data from the web application 165. After the requested service is known, the routine identifies the relevant request command for processing at step 225. If the requested service is not available to the web application then there will be no request command. The computer system 100 may be configured to log these unauthorized transaction requests. When the service requested is of a type that is known to the application, the routine continues to formulate the request file 153 in step 230. This formulation of the request file 153 based on a knowledge of the relevant request command and the data identified from the web application in step 220 is an embodiment of the translation logic 169 described in FIG. 2. Next, at step 235, the web application 165 provides the request file 153 to the shared-file database 150. This final step invokes the Internet API to write or otherwise establish the file in the shared-file database.

FIG. 4 illustrates an embodiment of a routine used by the web application 165 to retrieve and process response files 157. At step 250, the routine to retrieve and process response files begins. At step 255, the routine waits for the host-side server 110 to provide a response file 157 to the shared-file database. At step 260, the routine retrieves the response file 157. This is accomplished by using the Internet API 167 to read the file. At step 265, the routine verifies that the response file 157 contains valid data. If there is not a response containing valid data or if the system has timed out because there was not a response within a defined time interval, the routine returns a value of ‘false’ at step 290. If the response file 157 contains valid data, then at step 275, the routine matches the response data to the appropriate request.

Next, at step 280, the routine processes the response file. The nature of this processing may vary depending on the nature of the transaction processed. Processing includes translating the file into a format that is accessible to the web pages 171. Therefore, step 280 is also, in part, an embodiment of the web application's translation logic 169. Finally, at step 285, the routine deletes the response file 157 and returns to step 255 to wait for the next response file 157 to arrive. In this way, the shared-file database 150 does not overflow with response files 157 that are no longer required.

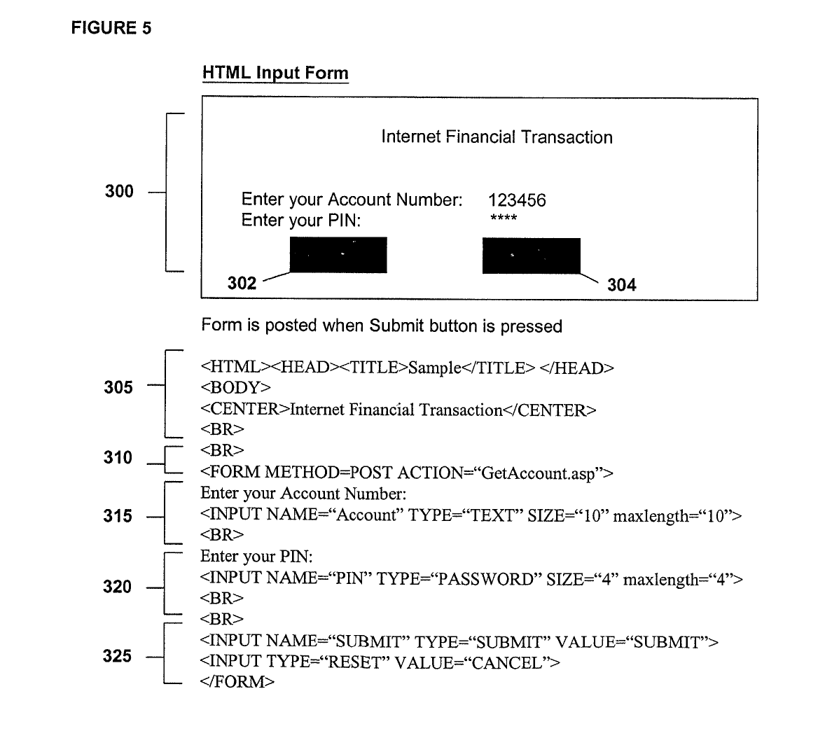

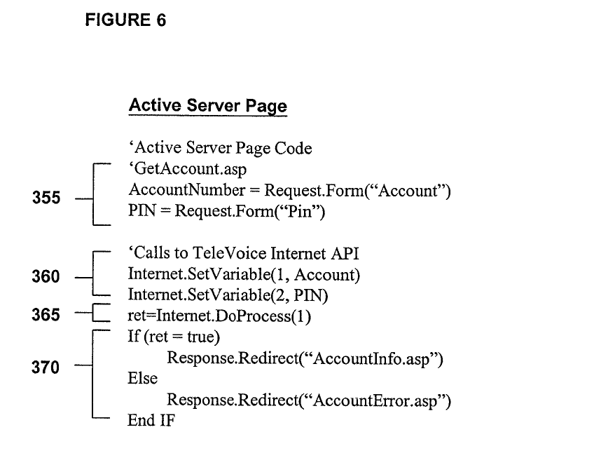

FIGS. 5-7 show code segments from a portion of a specific example of a web application. This example, applicable in a banking system or other application involving a PIN secured account number, captures user information and submits it to the host computer. FIG. 5 shows an example of an HTML web page. Specifically shown is an example of an input page 300 and the code segments 304-325 that created it. A ‘submit’ button 302 and a ‘cancel’ button 304 are elements of the web page created by those code segments. HTML code segment 305 formats the page and displays the heading “Internet Financial Transaction” in the center of the page. The next code segment 310 links the web page to the Active Server code segments 355-370 (shown on FIG. 6 which will be discussed later). The next segment 315 captures a user account number and code segment 320 captures the PIN number. Finally, the HTML code segment 325 captures a command, either ‘submit’ or ‘cancel’.

FIG. 6 contains code segments 355-370 that form the Active Server page mentioned above. When the user selects ‘submit’ the Active Server code segments that are linked to the HTML page are activated. Code segment 355 assigns the user account number and PIN to variables. Next, in code segment 360, two sequential calls are made to the Internet API 167. These function calls insert the two variables into a data structure that can be read by the host-side server. In this specific example, since there are only two variables, the two sequential function calls represent an embodiment of translation logic which takes the data from the web page and structures it into the format of the request files in the shared-file database.

Code segment 365 of FIG. 6 calls the Internet API 167 to provide a request file to the shared file to the shared-file database. If the request is successfully serviced, the return value of the variable “ret” will be ‘true’ and if the request is not successfully serviced, the value will be ‘false’. Next, at code segment 370, calls are made to Active Server output pages. If the request is successfully processed, then the routine “AccountInfo.asp” will process and display the results. If the request is not processed, then the routine “AccountError.asp” will perform appropriate error processing which may include presenting an account error message.

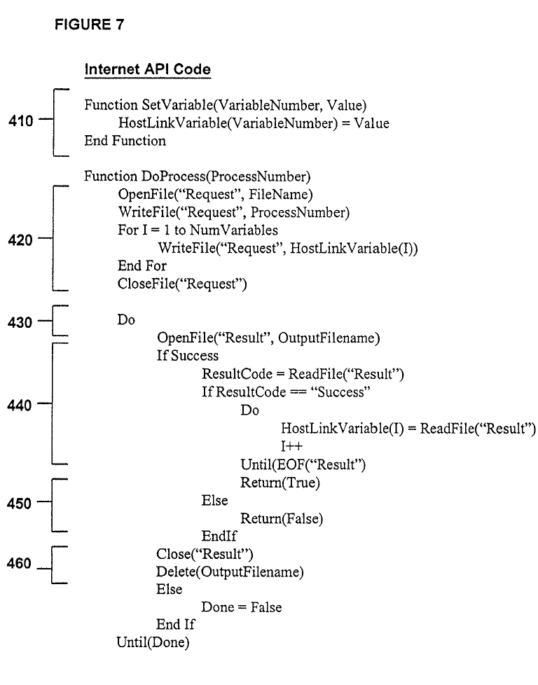

FIG. 7 contains code segments 410-460 which illustrate a specific example of a portion of the Internet API. Code segment 410 processes data from the web page by placing it in an array that can be written to a request file. Code segment 420 provides the request file to the shared file database. It opens a file of type “Request” with a definable filename and writes the request command, indicated by the variable ‘ProcessNumber’ to the file. Then it writes the array of variables, which in this case includes two elements, to the file and closes the file. Code segment 430 waits in a ‘do-loop’ until the host-side server has written a response file. In this specific example the Internet API waits indefinitely for a response file to appear. Once the file is written, code segment 440 receives the response file. If the host computer successfully processes the request, then the first element of the response file reads ‘Success’, code segment 440 reads the response data into an array, and code segment 450 returns a value of ‘True’. If the file indicates that the host computer is unsuccessful in processing the request, then code segment 450 returns a value of ‘False’. Finally, code segment 460 closes and deletes the response file.

Host Side Server and Sub-Elements

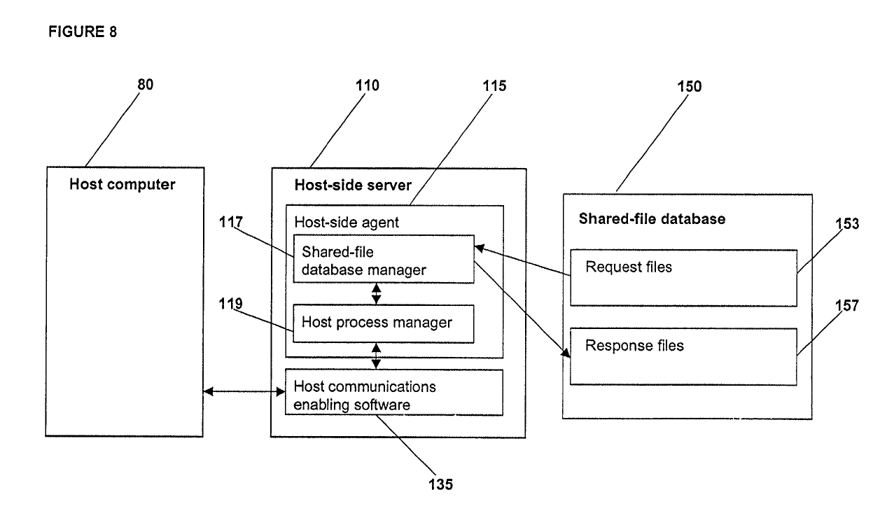

FIG. 8 depicts a block diagram of the host-side server 110, illustrating the interaction between the host-side agent 115 and the shared-file database 150. The host-side server 110 can be any kind of computer, including but not limited to a mainframe, workstation, or personal computer, that is capable of supporting a physical connection to the host computer 80 and has sufficient capacity to run host communication enabling software 135 and a host-side agent 115. The purpose of the host-side server 110 is to receive requests, (through request files 153) for host computer services from the shared-file database 150, process those requests, and provide a response file 157 containing the appropriate data. The host-side server 110 provides an added layer of security for the host computer because only transactions that the host-side server 110 is authorized to process will be transmitted to the host communication enabling software 135 and on to the host computer 80.

The host communications enabling software 135 is installed on the host-side server. This software is operatively connected to the host-side agent and the host computer 80 to transmit data and transaction requests to and receive data and error messages from the host computer 80. In one application, the host computer 80 is a mainframe computer running a transactional system, and the host communications enabling software 135 is a terminal emulator and screen-scraper application. This screen-scraper application operates by convincing the host computer 80 that the host-side server 110 is a dumb terminal. The host communications enabling software 135 may also be an interface written to a specific host application, database interconnectivity software such as ODBC, or an interface that is appropriate to the type of host computer 80 used in the system.

In one embodiment, the host side agent 115 primarily contains two elements: a shared-file database manager 117, and a host process manager 119. The shared-file database manager 117 may be a script, routine, program, or set of programs that are operatively connected to the shared-file database 150 so that it may retrieve request files, provide response files, and perform database management functions on the shared-file database 150. These database management functions may include, but are not limited to functions to create, read, write, and delete files, functions to allocate space, and functions to remove files that have persisted in the database beyond a defined time interval. The shared-file database manager 117 is also operatively connected to the host process manager 119. The host process manager may be a script, routine, program, or set of programs that process data retrieved from the request files 153 and structure and process data going to the response files 157. The shared-file database manager 117 and the host process manager 119 may be embodied in discrete code segments or integrated together in a common body of code. In the event that the shared-file database 150 is encrypted, encryption routines, such as an implementation of PGP or DES encryption software, may be linked to the shared-file database manager 117, the host process manager 119, or both.

In its operation, the shared-file database manager 117 retrieves request files 153 from the shared-file database 150. The shared-file database manager 117 communicates the contents of these files to the host-process manager 119. If the file includes a valid transaction request command, then the host process manager 119 initiates the appropriate processes on the host computer 80. The host process manager 119 communicates the necessary data and instructions to the host computer 80 by invoking the host communications enabling software 135.

When the host computer 80 has completed a transaction, the host communications enabling software 135 receives any return data and error messages and communicates them to the host process manager 119. From there, the host process manager 119 processes the data and error messages, putting the information into the format required by the web server 160. The formatted information is sent to the shared-file database manager 117 which provides (e.g., generates and conveys) a response file 157 to the shared-file database 150.

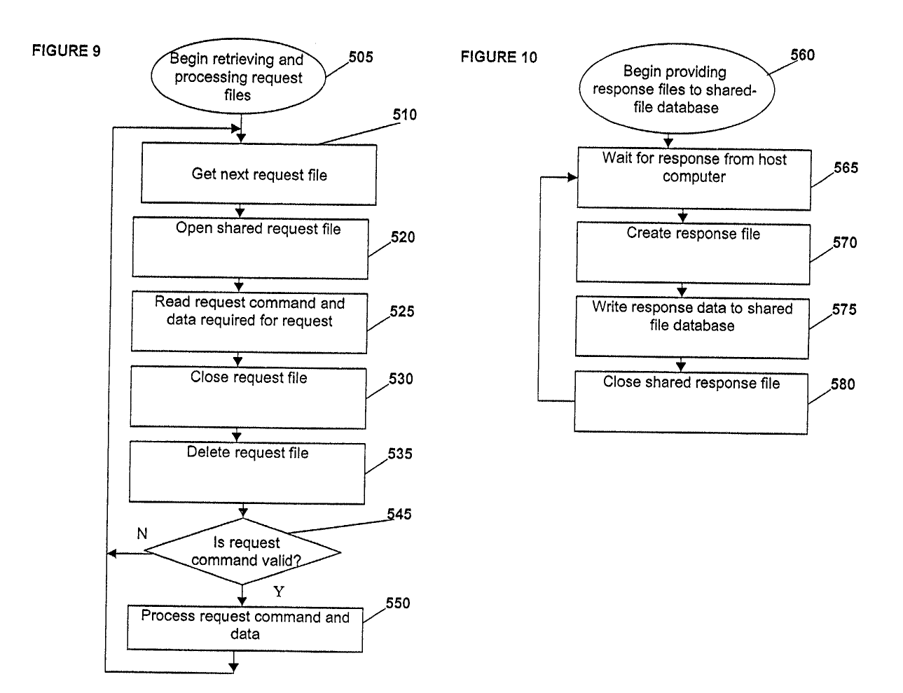

FIG. 9 illustrates one embodiment of a routine 505 performed by the host-side agent 115 to retrieve and process request files 153. In step 510, the routine retrieves (or waits for) a next request file to be processed. In step 520, the routine opens a shared request file. Authorized request files are written by the Internet API 167 and may contain a request command and data required for the request. At step 525, the routine reads the request command and any data in the file. Next, at step 530 the routine closes the file and at step 535 deletes it. By deleting files after they are read, the routine performs part of the function of the shared-file database manager 117 by ensuring that the shared-file database 150 does not overflow with files that are no longer needed.

Next, at step 545, the routine checks to see whether or not the transaction requested is valid. One of the security features of this computer system 100 is that it only permits a defined set of transactions to be run on the host computer 80. If the request command is invalid, the routine does not process the request, and the host computer 80 is protected. If the request is valid, the routine advances to step 550, which processes the request command and data. Performing this step is a part of the function of the host process manager 119 and involves initiating host computer transactions through the host communications enabling software 135. From here, the routine proceeds back to step 510 for processing a next request file.

FIG. 10 illustrates one embodiment of a routine executed by the host-side agent 115 to provide response files 157 to the shared-file database 150. At step 560, the routine to provide response files to the shared file-database 150 begins. First, at step 565, the routine waits for a response from the host computer 80. When there is a response, the routine creates the response file at step 570. This involves recognizing whether or not the host computer 80 successfully processes the transaction. If the transaction is successfully processed, then any data returned by the host is processed so that it can be read by the web server 160. If the transaction is not successful, then the response file will contain any appropriate error messages indicating transaction failure. After the response file 157 is created, the routine advances to step 575 where the data in the file is written to the shared-file database 150. Finally, in step 580, the routine closes the response file 157 and returns to step 565 to wait for the next host response.

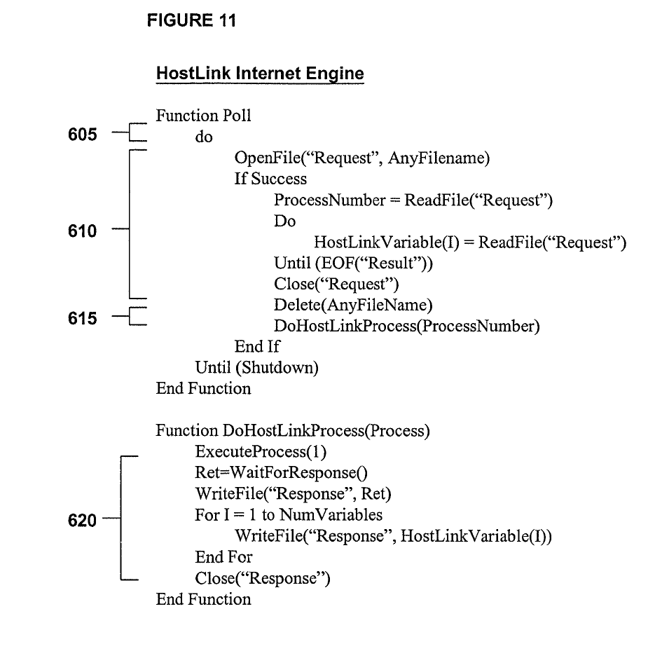

FIG. 11 contains code segments 605-620 that illustrate a portion of a specific example of host process manager. In this example, the shared-file database manager and the host process manager are merged into a single block of code comprising two functions labeled “Poll” and “DoHostLinkProcess”. The function “Poll” uses code segment 605 to wait in a do loop until there is a request file. When there is such a file, code segment 610 opens the file, reads the process number and data, then closes and deletes the file. After the data is read, code segment 615 makes a call to the “DoHostLinkProcess” function. This function begins by executing process “1” in code segment 620. In this specific example, “1” is the only allowable transaction request command. After initiating the transaction, code segment 620 waits for a response and creates a response file. If the transaction is processed successfully, the response file will contain the value “Success” and any appropriate data. If the transaction is not successful, the response file will contain the value “Fail” and an error message. By combining the functionality of accessing the shared-file database with the functionality to process a transaction request, the code segments 605-620 in this example combine some the functions of the shared-file database manager with the host process manager into a single block of code.

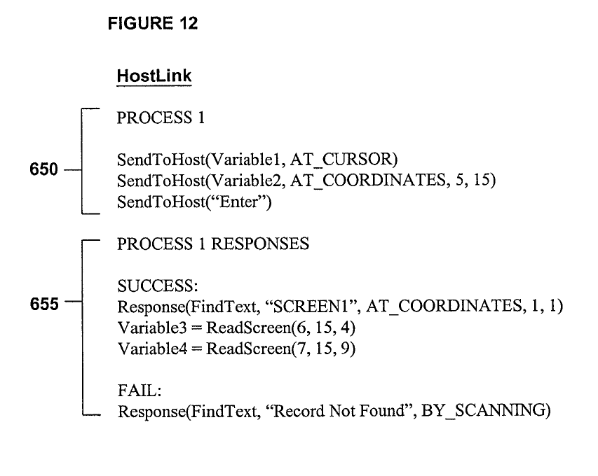

FIG. 12 shows code segments 650 and 655 which illustrate a portion of an example of a terminal emulator running a screen scraper. In this example, the terminal emulator functions as host communications enabling software. The terminal emulator convinces the host computer that the host-side server is a dumb terminal by converting transaction requests and input data into screens that are recognized by the host computer. Code segment 650 enters the account number and PIN into the appropriate fields on a mainframe computer screen. Code segment 655 ‘scrapes’ the response data from the screen. If the transaction is successful, two data items are captured from the screen. If the transaction is unsuccessful, an error message is captured. Together, these code-segments enable the host-side agent to communicate with the mainframe host computer used in this example.

Alternative Embodiments

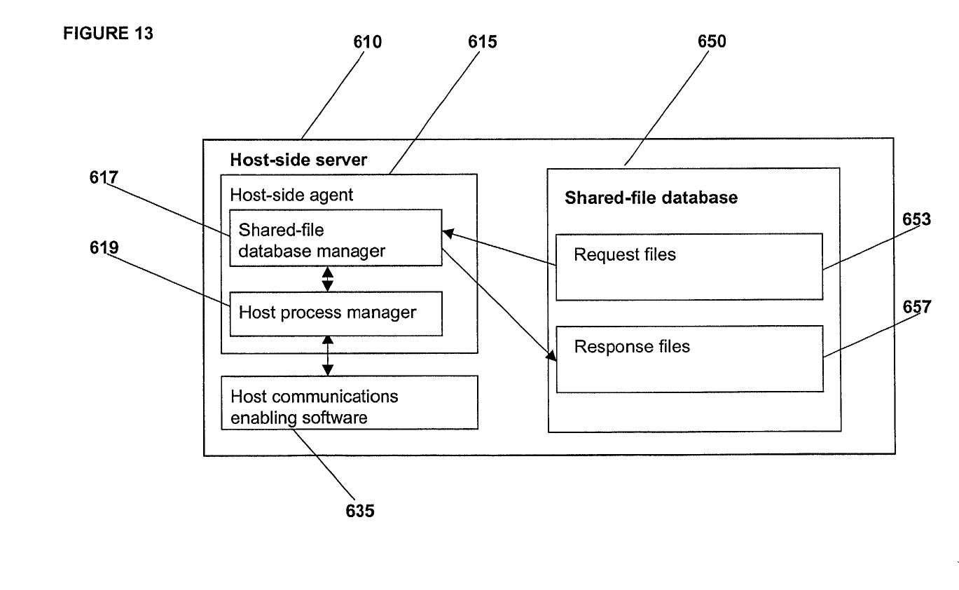

FIG. 13 shows an embodiment of a host-side server 610 in which a shared-file database 650 resides on the server. Although the shared file database 650 can be physically located on another computer, in the preferred embodiment it is placed on the host-side server 610. By placing the shared-file database 650 on the host-side server 610, the database is isolated from the Internet. This increases the security of the shared-file database 650 because an unauthorized Internet user does not have a direct connection to the host-side server.

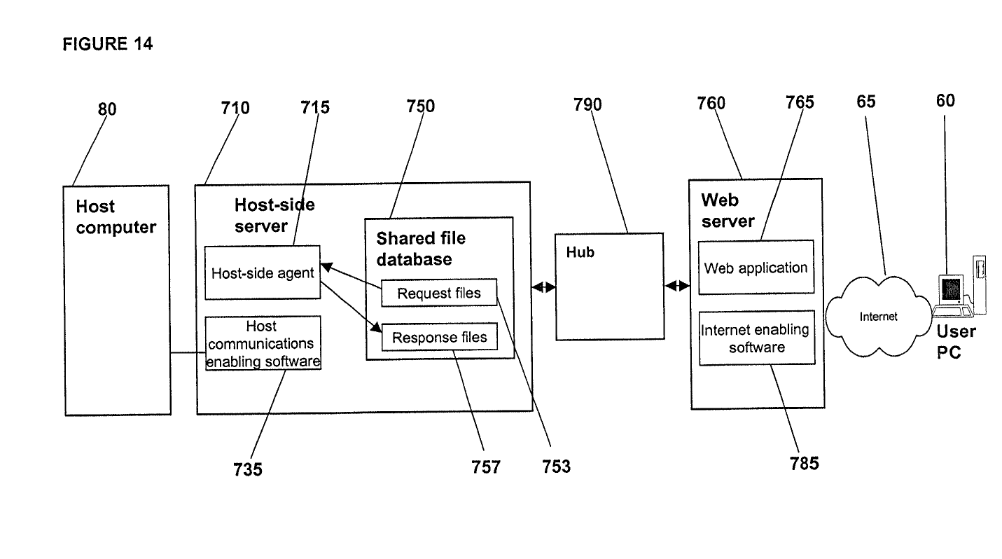

FIG. 14 shows an embodiment in which the physical connection through which the web server 760 accesses the shared-file database 750 is a hub 790. In this embodiment, the hub is connected to the web server 760 and to the host-side server 710. Because the shared-file database 750 in this embodiment resides on the host-side server 710, the hub 790 provides a path for the web application 765 to provide and retrieve files in the shared-file database 750. In an alternative embodiment, the shared-file database could be installed on a multi-ported storage device that forms a part of or is connected to the host-side server 710. This multi-ported storage device may be a dual-ported disk drive, operably connected to the host-side server 710 and to the web-server 760. In this embodiment, the web application 765 has a direct path to the shared-file database 750 through the port of the storage device that is connected to the web server 760. It is obvious to one who is skilled in the art that other means to provide a connection between the web-server and the shared-file database, such as a serial or parallel interconnect, could also be used to enable the web application 765 to provide and retrieve files from the shared-file database 750.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A computer system comprising:
a) a shared file database for storing one or more request files corresponding to transaction requests from a web client and one or more response files having information that is responsive to the transaction requests;
b) a web server operatively coupled to a host computer through the shared database, the web server having a web application for (i) providing to the shared file database one or more request files in response to receiving transaction requests from one or more web users, the request files complying with a predefined shared file format, and (ii) retrieving from the database response files, wherein the retrieved response files are processed to service the web requests; and
c) a host-side server adapted to be connected to the host computer, the host-side server having a host-side agent for (i) retrieving from the database request files that comply with the predefined shared file format, wherein the retrieved request files are processed for servicing associated web requests, and (ii) providing to the shared file database one or more response files in response to the request files being processed:

2. The computer system of claim 1, wherein the request files each include at least one request command from a set of predefined, permissible request commands.

3. The system of claim 1, wherein the host-side server comprises a computer platform having (i) a host-side agent operative to read from and write to the host computer and the shared-file database, and (ii) a host communications enabling program.

4. The system of claim 2, wherein the host communications enabling program is a terminal emulator.

5. The system of claim 2, wherein the host communications enabling software is an intelligent client application.

6. The system of claim 2, wherein the host-side agent further comprises a shared-file database manager and a host process manager.

7. The system of claim 6, wherein the host process manager translates the format of data received from the shared file database into a format recognizable by the host computer and translates host computer output into the shared-file format.

8. The system of claim 6, wherein the shared-file database manager polls the database and notifies the interface application of changes to the shared files.

9. The system of claim 6, wherein the shared-file database manager retrieves and provides shared files to the shared-file database.

10. The system of claim 6, wherein the shared-file database manager encrypts and decrypts files written to and read from the shared files.

11. The system of claim 10, wherein the shared-file database management application purges shared files after they have resided in the database for a user-defined interval.

12. The system of claim 1, wherein the web server comprises a computer platform having (I) an Internet enabling program for facilitating a web site that is available to the one or more web users, the Internet enabling program being operably connected to the web application.

13. The system of claim 11, wherein the web application comprises input and transaction web pages for receiving the transaction requests from the one or more web users.

14. The system of claim 13, wherein the web application comprises translation logic for translating a transaction request into a request file.

15. The system of claim 14, wherein the web application includes an Internet application program interface that is used by the web application to provide the request files to and retrieve the response files from the shared-file database.

16. The system of claim 1, further comprising a hub operably connected between the host-side server and the web server.

17. The system of claim 16, wherein the shared file database is implemented within the host-side server.

18. A method for securably accessing a host computer through a web site, comprising substantially exclusively connecting the web site to the host computer through a shared file database.

19. The method of claim 18, further comprising:
i) receiving from a web user a transaction request;
ii) translating the transaction request into a request file;
iii) transferring the request file to the shared file database; and
iv) processing the request file to service the transaction request if the request file complies with a predefined shared file format.

20. The method of claim 19, wherein the act of processing includes retrieving the request file from the shared file database with a host agent if the request file complies with a predefined shared file format.

21. The method of claim 20, further including providing to the shared file database a response file in response to the retrieved request file being processed.

22. The method of claim 19, wherein the shared file format dictates that a complying request file include one or more predefined, allowable request commands for implementing the transaction request.
